(19) United States
(12) Patent Application Publication
(10) Pub. No.: US 2005/0229500 A1
(43) Pub. Date: Oct. 20, 2005

(54) Fireplace surround system and method of making same

(76) Inventor: Joseph Edward Howard, Springfield, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/800,594

(22) Filed: Mar. 15, 2004

(51) Int. Cl. F24B 1/198; B29D 9/00; B29C 45/00; B29C 47/00

(52) U.S. Cl. 52/36.3

(57) ABSTRACT

A fireplace surround having the appearance of dry-stacked natural stone is composed of three single pieces, each of which appears to be composed of a plurality of pieces of stone. Additional pieces may optionally be added to increase the size of the surround. A method of creating masters for the pieces, as well as a method of forming the pieces of the surround, are also disclosed.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

1. Field of the Invention

This invention relates generally to fireplace constructions, and, more particularly, to assemblies for surrounding fireplace openings.

2. Related Art

The brick, stone, other masonry or wood detail surrounding a fireplace opening is known as a surround. Most commonly, surrounds are masonry structures prepared brick-by-brick by highly skilled and highly paid workers. Traditional brick surrounds, for example, are composed of numerous individual bricks separated from each other by grout. The grout is typically recessed between the bricks. The bricks are all of uniform shape, but typically one row of bricks is offset from adjacent rows so that the grouted vertical spaces between bricks do not line up from row to row of brick.

U.S. Pat. No. 4,727,698 addresses some of the issues arising from construction of traditional brick surrounds. This patent discloses a system in which a simulated brick surround (including the grout between bricks) is formed of first and second legs extending upwardly along the sides of the fireplace opening, topped by one or more brick simulating headers extending across the top of the opening (and across the top of the two legs).

An alternative to the traditional brick surround is the natural stone, dry-stack surround. These come in many styles. For example, one style uses a ledge stone that is cut into many small skinny pieces. This style is referred to a California Tight Fit Ledge. A second style also utilizes ledge stone but has not been cut into as many smaller skinny pieces. This style can be referred to as Traditional Country Ledge. By way of example, in a California Style Ledge sixty-four inch header; there can be fifty-three individual stones compared to thirty-five individual stones in the Traditional Country Ledge sixty-four inch header. The leg portions of such surrounds have corresponding numbers of individual stones as well. Both of these styles have the appearance of being dry-stacked (no mortar joint). There are many colors available in both of these styles, depending upon the stone being used.

The traditional natural stone, dry-stack surround can be improved. For example, it is both expensive and time consuming to construct a traditional natural stone, dry-stack surround. Unlike the brick surrounds, the variation in size and thickness of the raw materials (the stones) cannot be compensated for by using grout between the pieces, since the use of grout destroys the desired dry-stack appearance. This problem can be overcome somewhat by using artificial rather than natural stone in the construction of the surround. But that solution does nothing to reduce the time and expense involved in the actual construction process.

The process of U.S. Pat. No. 4,727,698 would not seem to be overcome the problems inherent in the construction of a dry-stack natural stone surround. This patent expressly teaches that the various parts (the legs, the header, and the hearth) are to be separated by grout which allows the “installer to adjustably custom shim” the parts with respect to each other. Use of such a system in a dry-stack natural stone surround would, therefore, destroy the dry-stack look which is desired.

### SUMMARY OF THE INVENTION

Among the objects and features of various embodiments of the present invention may be noted the provision of a fireplace surround having a natural stone, dry-stack appearance which is much less expensive and time-consuming to construct and install.

Another object is the provision of a method for making such a surround that preserves the desired look while drastically reducing the amount of labor required.

A third object is the provision of such a method that produces a surround that can easily be installed by a single worker.

A fourth object is the provision of a method for making a mold for a dry-stack appearing surround that accurately reproduces the desired look when surround pieces are made in the mold.

Further features and advantages of the present invention, as well as the structure and operation of various embodiments of the present invention, are described in detail below with reference to the accompanying drawings.

In a first aspect of the present invention a fireplace surround having the appearance of dry-stacked stone includes a first leg adapted to be disposed vertically on one side of a fireplace opening, a second leg adapted to be disposed vertically on an opposing side of the fireplace opening, and a header adapted to be disposed horizontally over the fireplace opening. The first leg is composed of a single molded piece of material which has a face with the appearance of a plurality of non-uniform, dry-stacked stones. The single molded piece of material making up the first leg also has an outer edge with an irregular appearing shape simulating the appearance of dry-stacked stones and a substantially flat back. The face and the back are opposing surfaces. The second leg and the header are similarly constructed. The header differs from the legs in that it has two opposing outer edges with irregular appearing shapes simulating the appearance of dry-stacked stones whereas the legs need only have one such outer edge. (The edge of the legs adjacent the openings is preferably, although not necessarily, flat.) The header has a substantially flat base surface and the first and second legs have substantially flat top surfaces such that when the header is placed upon the top surfaces of the legs without grout between the header and the legs, the assembly of the header and the legs fit closely together and give the appearance of a unitary structure of dry-stacked stone.

In a second aspect of the present invention, a method of making a mold for a fireplace surround having the appearance of dry-stacked stone includes assembling a plurality of individual pieces of stone into a dry-stack corresponding to at least a portion of a desired fireplace surround. (A “dry-stack” in this context is an assembly of natural or artificial stone having the appearance of individual stones dry-stacked together in the conventional manner.) The dry-stack has a substantially flat top surface, a substantially flat back surface, and at least one irregular exposed surface. The method includes sealing the dry-stack, securing the back surface of the dry-stack to a mold base, providing a containment structure around the dry-stack, and pouring a liquid, settable rubber material (preferably but not necessarily artificial urethane rubber) over the dry-stack in the containment structure. The rubber material cures in place over the dry-stack so that the rubber material forms a mold of the dry-stack. The cured rubber material is then removed as a unit from the containment structure to expose a mold cavity in the cured rubber material corresponding in shape to the dry-stack.

In a third aspect of the present invention, a method of forming pieces of a fireplace surround having the appearance of dry-stacked stone includes selecting a rubber mold for at least one piece of a fireplace surround, the mold having a mold cavity with a face surface, a top surface and at least two side surfaces, the face surface being configured to create a molded part having the appearance of a plurality of dry-stacked stones, said top surface being substantially flat, and at least one of said side surfaces being configured to create a molded part having the appearance of the ends of a plurality of dry-stacked stones. The mold cavity is substantially filled with a slurry of artificial stone forming concrete material, the mold is vibrated with the slurry disposed in the mold cavity to eliminate cavities, anchors are inserted into the slurry in the mold cavity, and the slurry is cured while the anchors are in place to form a single solid piece of artificial stone having the appearance of a plurality of dry-stacked stoned. Once the slurry is cured, the single, solid piece of artificial stone is removed from the mold.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a front plan illustrating a fireplace surround of the present invention;

FIG. 2 is a cross-sectional view illustrating a method of attachment of the fireplace surround of FIG. 1;

FIG. 3 is a view similar to FIG. 1 illustrating an optional hearth;

FIG. 4 is a perspective view illustrating a master for a part of the fireplace surround of the present invention; and

FIG. 5 is an elevation illustrating the formation of a containment area for the formation of a mold from the master of FIG. 4.

Similar numerals indicate similar parts throughout the various views of the drawings.

### DETAILED DESCRIPTION OF THE PREFERRED EMBODIMENTS

Turning to the drawings, a fireplace surround system 11 of the present invention is for use to face off a zero clearance manufactured fireplace 13. Although a particular manufactured fireplace 13 is shown, it should be realized that the present invention is of general applicability and is not limited to use with any particular manufactured fireplace. System 11 using several parts that are cast out of light weight concrete replicating the look, feel, and color of natural or man made stone. This unit consists of two twelve inch wide legs 15, 17 that are thirty-seven inches tall. The thickness of each leg can vary from, for example, 1.5 inches to 2.5 inches, reflecting the natural variation in stone sizes. Different thicknesses could, of course, be used. The twelve inch width of each leg is nominal. It can increase in places (to, for example, fourteen inches) based on the width of the individual stone corner pieces on the outside edge of the part.

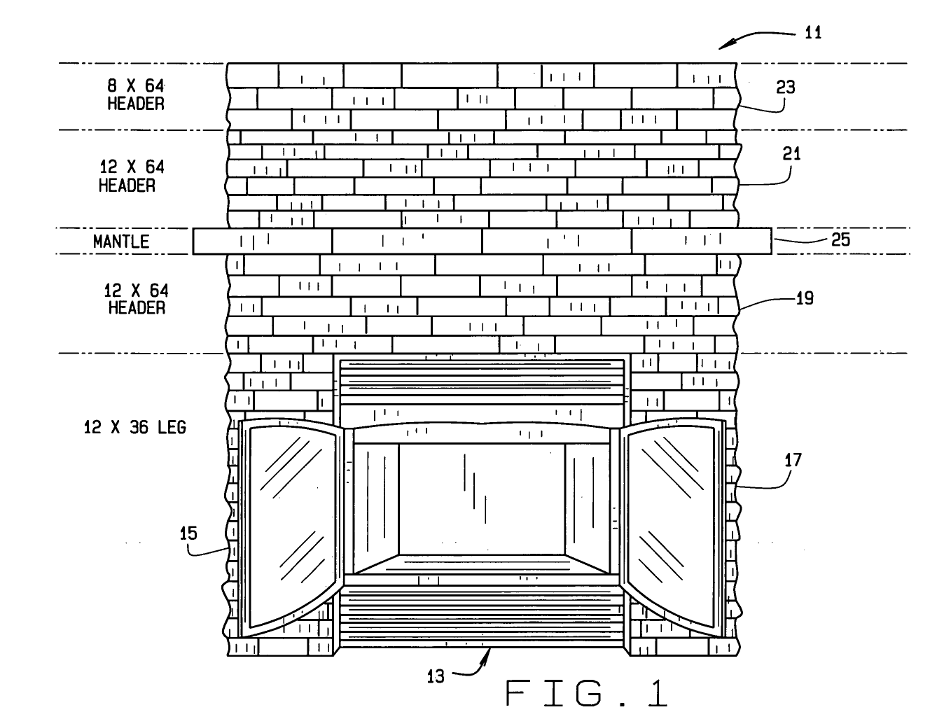

A header 19 sits on top of the two legs 15, 17. Header 19 is sixty-four inches long and twelve inches tall. Several header pieces (additional headers 21, 23 are shown) can be stacked as high as desired. A mantle 25 may also be included, if desired. As can be seen in FIG. 1, the headers may come it two different heights (eight inches for header 23 and twelve inches for headers 19, 21, for example) if desired to fill the space.

Surround system 11 is designed to fit all zero clearance fireplaces that have a glass width of no more than thirty-six inches. The dimensions given above will fit ninety-eight percent (98%) of the thirty-six inch zero clearance fireplaces manufactured. Manufactured fireplaces also come in a forty-two inch width. Increasing the width of headers 19, 21, 23 to sixty-seven inches will accommodate most forty-two inch zero clearance fireplaces.

It has been found that fireplace surround system 11 provides light weight, ease of installation, and replication of natural stone, at a very reasonable price. By way of illustration, any laborer can install system 11—one does not have to be a stone mason to install system 11.

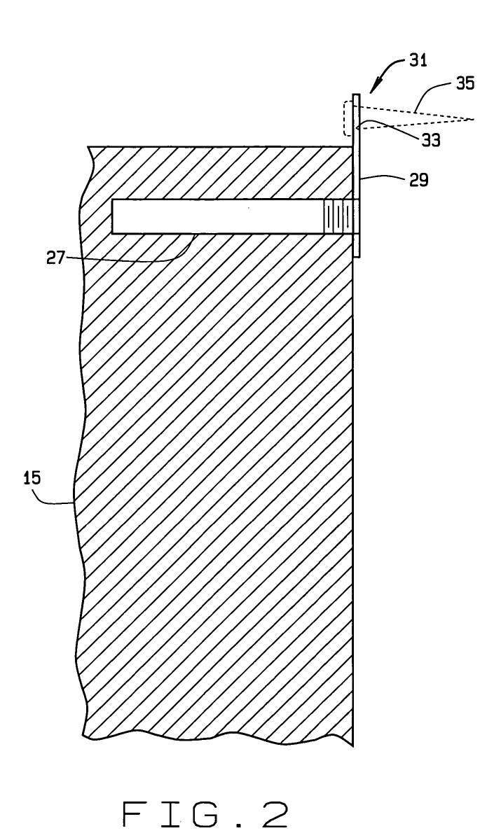

Fireplace surround system 11 is designed to be installed by anyone possessing nominal skills and basic hand tools. The parts to this system (legs 15, 17, headers 19, 21, 23, and any ancillary parts) are extremely strong yet lightweight and can be handled by one person. Each part has several anchors 27 (see FIG. 2) embedded into the back of the parts (15, 17, 19, 21, 23). The shape and number of anchors 27 vary since there are a variety of concrete anchors available on the market. A small 16-gauge piece of metal 29 is screwed into the anchors. Metal pieces 29 have tabs 31 that protrude above the part (15, 17, 19, 21, 23) and have a small hole 33 at the top so that they can have a one inch sheet rock screw 35 placed through the hole then screwed into the wall that the fireplace surround system 11 is placed against. Of course, the size and type of pieces 29 and fasteners 35 is a matter of choice. Those described herein are illustrative only. It is preferred that a suitable adhesive product such as that sold under the trade designation Liquid Nails be applied liberally across the back of each part (15, 17, 19, 21, 23) before the part is screwed into the wall.

The two legs 15, 17 are set up first against the wall and overlapping the face of the zero clearance fireplace 13, depending upon the width of the fireplace unit. After the legs 15, 17 are screwed into the wall, the header 19 has a suitable adhesive such as that sold under the trade designation Liquid Nails applied to its back surface. The header 19 is then set on top of the two leg units 15, 17, and then screwed into the wall. Additional header units 21, 23 and/or mantle 25 can be set in the same manner. If the zero clearance fireplace 13 is shorter than thirty-five inches, the legs can be cut on the bottom using a hand grinder with a masonry blade or a circular saw with a masonry blade. It is preferred that the bottoms of the legs 15, 17 be cut (as opposed to the top) so that the header 19 will sit flush on top of the legs. The optional stone mantle 25 should be placed on top of one of the headers. The mantle, for example, may be formed of two two-inch stones with a chipped front edge. These stones are thirty-two inches wide and six inches deep. The far left and far right outer edges of these mantle stones have a chipped appearance. Additional headers (such as header 21) above the mantle may be inverted as they are stacked in order to prevent to look of repetition in the stone patterns.

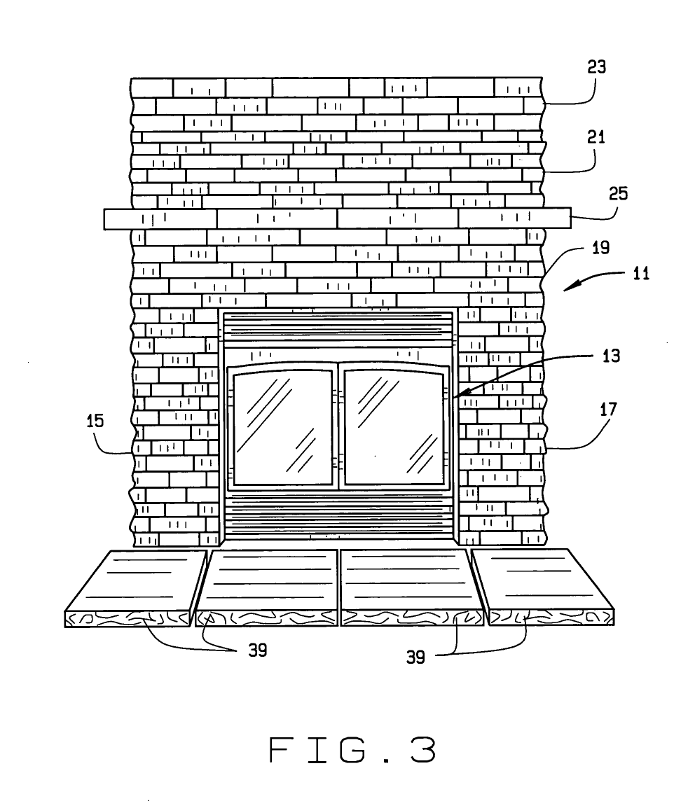

If desired an optional raised hearth extension (not shown) may be installed in the same manner as the other parts. The front face piece of the extension uses an eight or twelve inch header depending the height of the hearth. Two return pieces are fastened into place the same way as the other parts. For example, the hearth return pieces may be sixteen inches long and eight inches tall. They connect from the front face of the raised hearth and return back to the wall that the fireplace is flush mounted in. Four hearth stones 39 (FIG. 3) measuring 16¾ inches wide by 19 inches deep are then glued onto the top of the hearth. By way of illustration, the hearth stones may be two-inch thick stones with a chipped front edge. A typical dimension for the hearth stones is 16¾ inches wide by 19 inches deep. The raised hearth application takes four of these hearth stones. The far left and far right hearth stones have a chipped front edge as well as the side edges. The two middle hearth stones only have a chipped edge on one side which is placed in the front of the hearth extension.

FIG. 3 (along with FIG. 1) illustrate the fact that the outer surfaces of the legs and headers (those surfaces disposed horizontally the furthest distance from the fireplace opening) have an irregular appearance corresponding to the look of natural, dry-stacked stone. The face of all the parts (that portion facing into the room) also has such an irregular, dry-stacked stone look. The edges adjacent the fireplace opening, however, are preferably flat so as not to interfere with the operation of the fireplace doors.

The legs and headers are all made using the same basic process described below. In this process, a master of each part (leg 15, leg 17, header 19, header 23) is made first; a mold is formed from the master using a two-part artificial rubber; and the parts themselves are then cast in the corresponding molds created from the masters. Note that headers 19 and 21 are identical (although mounted inverted with respect to each other), so the same mold can be used for both these parts.

The preferred materials used in making the masters are set forth below. It should be appreciated that other materials having similar properties could just as well be used.

For the stone used in making the masters, it is preferred that a cast stone be used such as that sold under the trade designation Ledge Stone Veneer by Palisades Stone in Springfield Mo. This stone varies in thickness between one to two inches thick. There are many sizes and shapes to this pattern. It is believed to be made of light weight expanded shale aggregate manufactured by Buildex, Lone Star Portland Cement type I, plasticizer, micro silica manufactured by General Resource Technology, iron oxide color pigments manufactured by Dynamic Color Solutions, and river sand. This stone is casted in molds and is then used for the surround system.

Each master is formed on a base of suitable strong, flat material such as plywood. For example, the artificial stones making up the master dry-stack may be bonded to a 3/4 inch thick plywood using a suitable adhesive such as that sold under the trade designation MP6000 Liquid Nails. As each master dry-stack is being constructed (as explained below), the various stones are bonded to each other using (for example) vinyl spackle. Any other adhesive that bonds the stones together and seals the dry-stack against infiltration of the liquid rubber in the mold creation step, without affecting the dry-stack look may be used as well. Moreover, as is also described below, a clear acrylic spray is preferably used to seal each master dry-stack assembly before molding. A suitable release agent (such as the cooking spray sold under the trade designation Pam) is also used.

The preparation of the masters does not require specialized equipment. For example, a wet tile saw (used to cut stone veneer for the masters), a table saw and cut-off saw (used for cutting lumber for masters and molds), and miscellaneous hand tools (such as levels, drills, hand grinders, squares, putty knifes, caulk gun) are all that is required. In addition, as will appear, four-inch tall pieces of steel C-channel are used to form a containment area for the liquid rubber mold material around the masters. The particular shape of the steel channel, of course, is not of particular importance so long as the rubber material is held in place while it cures and so long as the mold releases from the containment structure after curing.

The mold material itself is preferably a two part pourable liquid rubber material manufactured by Synair Inc. and sold under the trade designation SX-30. Other pourable mold materials suitable for molding cementious parts may be used instead. Part A and Part B of this material are mixed together in equal volume amounts, and then mixed together using a paddle mixer on a hand drill. After being mixed, the material is poured over the master. It is pulled off the master part after curing for twenty-four hours. The curing time could vary, of course, depending upon the material being used.

The preparation of each master is similar and is as follows: Each artificial stone making up the master is carefully cut square using a wet tile saw, for example. The stone is cut into ½ inch height increments. Some stones that will vary in thickness from 1 inch to 2 inches, but the height increment of ½ inch applies to all the stones. (Of course, a different increment could be used, if desired, but some increment is necessary to achieve the desired dry-stack look in a multi-part assembly (legs and headers). The lengths of some of these stones may vary from, for example, two to thirteen inches. The heights of the stones can also vary from, for example, one to five inches.

It is important that the stones for the masters be cut square so that they can be dry stacked. By dry-stacking the stones, the mold material will not flow in between the joints of the stones, thus making the mold easier to pull off the master. The individual stones are then glued to plywood cut to the dimensions of the part. While applying a suitable adhesive such as that sold under the trade designation Liquid Nails to the back, flat surface of the stones; vinyl spackling is buttered on all four sides of each stone to create a seal between the stones without affecting the dry-stack appearance. After the adhesive and the vinyl spackling have dried, clear spray acrylic is then lightly sprayed over the entire master to seal the dry-stack. After the acrylic has dried, a release agent such as the aforementioned cooking spray is applied to the dry-stack, and the master is now ready for the pourable mold material.

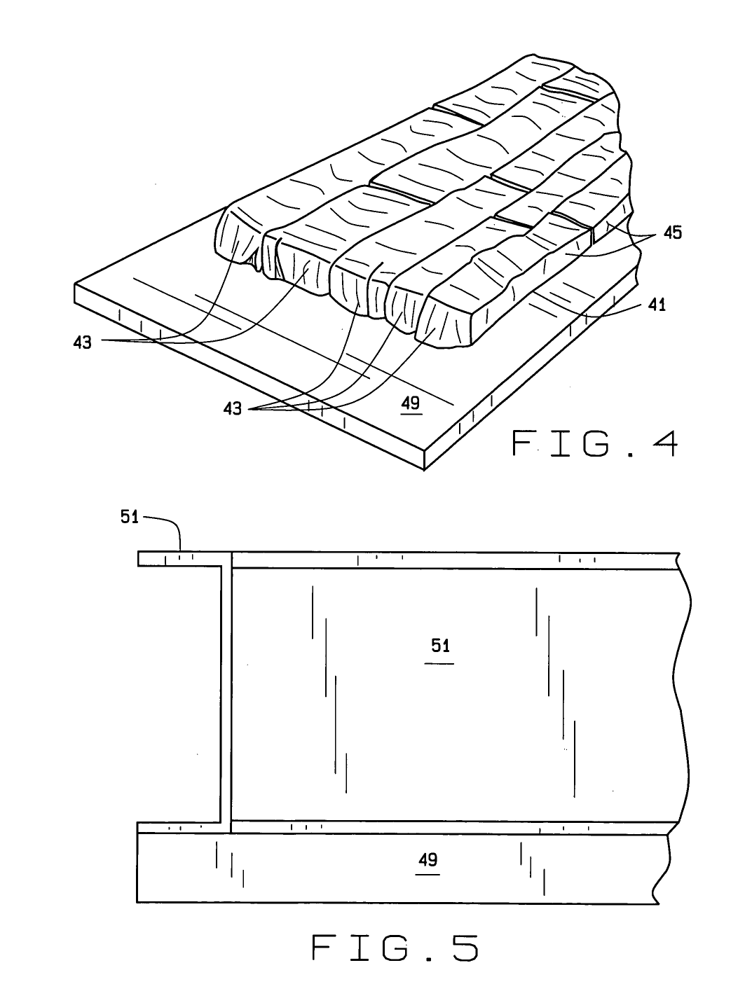

The formation of the masters for the headers illustrates the process. Fireplace surround system 11 is designed to have header pieces that can be stacked one on top of another. As a result, the long edges (the edges between adjacent headers) must be perfectly square. If they were not, the surrounds would have an unacceptable gap between them when being stacked. To accomplish the square edges, the individual stones being cut must be cut square. These pieces are then glued and spackled to a piece of plywood 41 measuring twelve inches wide by sixty-one inches long and 3/8 inch thick. See FIG. 4. The back of these stones 43 may need to be shaved off so that there is a notch in the corner that will overhang the sixty-one inch plywood backer board 41. Other dimensions could be used if desired, so long as suitable support is provided for the dry-stacked artificial stones. The corner pieces 43 are first applied then intermediate stones 45 are filled in to the next edge where they meet with the other corner pieces. After this part is finished, it is then applied on top of a ¾ inch thick plywood sheet 49 measuring an additional two inches on all outside dimensions. Vinyl spackling is used on the edges to smooth out any variances in the stone. These edges are then faired and checked for squareness. They are spackled and faired over again if necessary. All other parts are constructed in the same manner as described above.

Silicone caulk is used after the stones have been glued and spackled to the plywood. The silicone is applied around the entire bottom edge of the master part where the stones meet with the plywood. This will prevent the pourable mold material from seeping under the stones thus make mold removal must easier.

At this point the steel C-channel 51 may be suitably attached to the ¾ plywood sheet 49 to provide a containment area around the master being constructed. See FIG. 5. The four-inch C channel is preferably cut into lengths one inch longer than the ends of the master parts and ½ inch wider than the long sides of the master parts. Steel is used because the pourable rubber material will not bond to steel and these frames can be used over. This forms a steel frame than encompasses the master part and creates a containment area for the mold material. The inside corners of the frame are sealed with silicone to prevent mold material from seeping out. Weather stripping is preferably used on the bottom edge that sits on the 3/4 inch plywood to also prevent the mold material from seeping out. These frames made of C-channel 51 are then screwed into the ¾ inch plywood 49. The resulting mold will then have outer walls that will be ½ inch thick on the long sides and 1 inch thick on each short end of the master part. Of course, the wall thickness of the mold can be varied, but this wall thickness has been found to work well.

The two part pourable urethane rubber material described above is extremely reactive to moisture. Any moisture present in the process of pouring the rubber will prevent the chemical transformation needed in order for the rubber to set properly. Great care should be taken in preparing the masters and mixing equipment to ensure that there is no significant moisture left in or on the master. Also, the particular material described has a suggested use range of from sixty degrees Fahrenheit to no more than eighty degrees Fahrenheit, with very little outside humidity. Moreover, the two parts of rubber must be mixed substantially in equal proportions. If not, or if they are not mixed adequately, the rubber will not set properly to form the mold.

All material used in creating the masters are preferably allowed to dry overnight. This includes the adhesive used to adhere the stones to the plywood, the vinyl spackling used between the stones, the silicone caulk used around the edges of the masters, and the acrylic spray used to seal the concrete pours in the stones. The release agent is the only material that does not have to be dry before the next step.

After the liquid urethane rubber mixture is poured into the containment area around and over the master, it is allowed to set for the recommended initial cure time-in this case twenty-four hours. At this point, the rubber will be hard and ready to be pulled off the master. The mold simply pulls off the master part by hand and then is allowed to cure at room temperature for another twenty-four hours. After this, the mold is now ready to pour the legs and headers, as described below.

A mold release agent, by way of example, a solution of methyl alcohol and castor oil, is first put in the mold cavity. After the mold release agent has been added, surface shade color may be put in the mold cavity, if desired. The preferred shade color is an iron oxide color hardener manufactured by Dynamic Color Solutions. The shade color or colors, depending on which fireplace surround system color is desired, is sprinkled into the mold. After the color shade is applied, the mold is now ready for the lightweight concrete mixture, hereinafter described. This concrete material is made in batches using a gas powered mortar mixer. A bag (94 pounds) of Portland cement, internal color, plasticizer, micro silica, fiberglass strands, and water are added to the mixer. Then the expanded shale aggregate and river sand are added to batch and allowed to mix for a suitable time, such as fifteen minutes. After the proper slump is produced, the slurry mix is poured into the molds while sitting on a vibration table. After the molds are filled to the top and while still being vibrated, reinforcing material, such as three sixteen-gauge wires as long as the molds are long are inserted into the slurry mix in the molds. The molds are then removed from the vibration table and concrete anchors 27 are placed into the wet mix down to the surface of the concrete. The concrete material in the molds is then allowed to cure a suitable amount of time, such as overnight.

After the suitable curing period, the concrete slurry has set up. The molds containing the molded parts are then flipped over and the rubber mold is pulled off the concrete. The fireplace system parts (legs 15, 17, and headers 19, 21, 23) are then placed on curing racks and allowed to cure for a suitable period of time, such as seven days, before being packaged and shipped.

In view of the above it will be seen that the various objects and features of the present invention are achieved and other advantageous results obtained. The description of the invention above is intended to be illustrative only and is not intended to limit the scope of the claims, which claims define the scope of the present invention.

1. A fireplace surround having the appearance of dry-stacked stone, comprising:
a first leg adapted to be disposed vertically on one side of a fireplace opening;
a second leg adapted to be disposed vertically on an opposing side of the fireplace opening;
a header adapted to be disposed horizontally over the fireplace opening;
said first leg comprising a single molded piece of material, said single molded piece of material having a face with the appearance of a plurality of non-uniform, dry-stacked stones, an outer edge with an irregular appearing shape simulating the appearance of dry-stacked stones, and a substantially flat back, said face and said back being opposing surfaces;
said second leg comprising a single molded piece of material, said single molded piece of material having a face with the appearance of a plurality of non-uniform, dry-stacked stones, an outer edge with an irregular appearing shape simulating the appearance of dry-stacked stones, and a substantially flat back, said face and said back being opposing surfaces;
said header comprising a single molded piece of material, said single molded piece of material having a face with the appearance of a plurality of non-uniform, dry-stacked stones, and having opposing outer edges with irregular appearing shapes simulating the appearance of dry-stacked stones, said header having a substantially flat back;
said header having a substantially flat base surface and said first and second legs having substantially flat top surfaces such that when the header is placed upon the top surfaces of the legs without grout between said header and said legs, the assembly of the header and the legs fit closely together and give the appearance of a unitary structure of dry-stacked stone.

2. The fireplace surround as set forth in claim 1 wherein the first leg and second leg have a height of over thirty six inches.

3. The fireplace surround as set forth in claim 2 wherein the first and second legs are made of the same material, said legs made of said material being sawable or grindable along the bottom of said legs to adjust the length of the legs.

4. The fireplace surround as set forth in claim 1 wherein at least one of the legs have an inner edge, opposite the outer edge that is substantially flat, said inner edge being adapted to be disposed adjacent the fireplace opening.

5. The fireplace surround as set forth in claim 1 wherein the first leg and the second leg have embedded therein a plurality of anchors for use in attaching the legs to a wall adjacent the fireplace opening.

6. The fireplace surround as set forth in claim 1 wherein the header has embedded therein a plurality of anchors for use in attaching the header to a wall adjacent the fireplace opening.

7. The fireplace surround as set forth in claim 1 wherein the header has substantially flat top surface.

8. The fireplace surround as set forth in claim 1 further including a second header, both headers being substantially identical in structure and appearance when both headers are oriented in the same direction, the second header having a different appearance when it is inverted so that the face of the two headers do not appear to be identical when one header is placed inverted above the other header with the faces of both headers facing the same direction.

9. The fireplace surround as set forth in claim 1 wherein the material making up the legs and the header is a cementious material.

10. The fireplace surround as set forth in claim 9 wherein the legs and the header have a surface shade color disposed therein.

11. The fireplace surround as set forth in claim 1 wherein the header has a length of over sixty inches.

12. The fireplace surround as set forth in claim 11 wherein the header has a length of approximately sixty-four inches and the legs have a length of approximately thirty-seven inches.

13. The fireplace surround as set forth in claim 11 wherein the header has a length of approximately sixty-seven inches.

14. A method of making a mold for a fireplace surround having the appearance of dry-stacked stone, comprising:
assembling a plurality of individual pieces of stone into a dry-stack corresponding to at least a portion of a desired fireplace surround, said dry-stack having a substantially flat top surface, a substantially flat back surface, and at least one irregular exposed surface;
sealing the dry-stack;
securing the back surface of the dry-stack to a mold base;
providing a containment structure around the dry-stack;
pouring a liquid, settable rubber material over the dry-stack in the containment structure;
curing the rubber material in place over the dry-stack so that the rubber material forms a mold of the dry-stack;
removing the cured rubber material as a unit from the containment structure to expose a mold cavity in the cured rubber material corresponding in shape to the dry-stack.

15. The method as set forth in claim 14 wherein the stone is artificial stone.

16. The method as set forth in claim 14 wherein the stone is natural stone.

17. The method as set forth in claim 14 wherein the flat top surface of the dry-stack is artificially produced.

18. The method as set forth in claim 14 wherein the stones of the dry-stack are individually secured to the mold base.

19. The method as set forth in claim 14 wherein the stones of the dry-stack are at least partially covered with a sealing material prior to the dry-stack being secured to the mold base, said sealing material not substantially affecting the appearance of the dry-stack.

20. The method as set forth in claim 14 wherein the dry-stack is sealed prior to the pouring of the liquid, settable rubber material.

21. The method as set forth in claim 20 wherein the sealing of the dry-stack is performed with a material that does not substantially affect the appearance of the dry-stack.

22. The method as set forth in claim 14 wherein the dry-stack secured to the mold base forms a master that may be reused to create additional molds.

23. The method as set forth in claim 14 wherein the steps of the method are repeated for a first leg, a second leg, and a header of a fireplace surround.

24. A method of forming pieces of a fireplace surround having the appearance of dry-stacked stone, comprising:
selecting a rubber mold for at least one piece of a fireplace surround, said mold having a mold cavity with a face surface, a top surface and at least two side surfaces, the face surface being configured to create a molded part having the appearance of a plurality of dry-stacked stones, said top surface being substantially flat, and at least one of said side surfaces being configured to create a molded part having the appearance of the ends of a plurality of dry-stacked stones;
substantially filling the mold cavity with a slurry of artificial stone forming concrete material;
vibrating the mold with said slurry disposed in the mold cavity;
stopping the vibrating of the mold;
inserting anchors into the slurry in the mold cavity;
curing said slurry while the anchors are in place to form a single solid piece of artificial stone having the appearance of a plurality of dry-stacked stoned;
removing the single, solid piece of artificial stone from the mold.

25. The method as set forth in claim 24 wherein the rubber material is a urethane rubber material.

26. The method as set forth in claim 24 wherein the liquid rubber material is a two-part artificial rubber material.

27. The method as set forth in claim 24 further including the step of inserting a colorant into the mold cavity prior to the step of filling the mold cavity with the slurry.

28. The method as set forth in claim 27 wherein the colorant is a dry, powdered surface colorant.

29. The method as set forth in claim 24 further including the step of inserting reinforcing wires into the slurry while the slurry is disposed in the mold cavity.

30. The method as set forth in claim 24 further including the step of inserting mounting anchors into the slurry while the slurry is disposed in the mold cavity.
